(19) United States
(12) Patent Application Publication
(10) Pub. No.: US 2002/0086796 A1
(43) Pub. Date: Jul. 4, 2002

(54) Catalytic element with restrictor layer

(76) Inventors: Bernd Eckardt, Bruchkobel (DE); Malte Berndt, Sinsheim (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 09/968,586

(22) Filed: Oct. 1, 2001

Related U.S. Application Data
(63) Continuation of application No. PCT/DE00/00797, filed on Mar. 15, 2000.

(30) Foreign Application Priority Data
Mar. 31, 1999 (DE) 199 14 823.6

(51) Int. Cl. B01J 21/00

(52) U.S. Cl. 502/339; 502/527.12; 502/355

(57) ABSTRACT

A catalytic element includes a catalyst body with a catalytic surface and a restrictor layer disposed on the catalyst body for inhibiting diffusion of reaction gases. The catalyst body recombines hydrogen with oxygen and/or carbon monoxide with oxygen. The restrictor layer is porous, is disposed on the catalytic surface, and has a layer thickness varying in the direction of flow of the reaction gasses. The restrictor layer also can have a varying pore diameter that varies in the direction of flow of the reaction gasses. The restrictor layer can be ceramic and include aluminum oxide or silicon oxide, include minerals, be formed from a mineral bed, be metallic, be a metal foil, or include metallic or ceramic fibers forming a mesh.

### CROSS-REFERENCE TO RELATED APPLICATION

This application is a continuation of copending International Application No. PCT/DE00/00797, filed Mar. 15, 2000, which designated the United States.

### BACKGROUND OF THE INVENTION

### Field of the Invention

The invention relates to a catalytic element for recombination of hydrogen and/or carbon monoxide with oxygen, having a catalyst body with a catalytic surface, in particular for a nuclear power plant.

German Patent DE 199 14 814 C1, deals with a similar theme.

After a fault involving loss of coolant, large quantities of hydrogen and carbon monoxide may be liberated in containments of a nuclear power plant. Without countermeasures, the levels of hydrogen in the atmosphere of the containment may rise to such an extent that a detonatable mixture may form. In the event of accidental ignition, the integrity of the containment could be jeopardized by the combustion of a relatively large quantity of hydrogen.

Various devices show how to prevent explosive gas mixtures of this type from forming in the containment. These include, for example, devices such as catalytic recombiners, catalytically and electrically operated ignition devices, or a combination of the two devices referred to above.

The intention achieves early and flame-free recombination of the hydrogen and/or the carbon monoxide with oxygen to eliminate the hydrogen and the carbon monoxide from the atmosphere of the containment. The intention also reliably avoids any significant build-up of pressure as a result of a virulent combustion of hydrogen. An early-starting recombination device that is suitable for this purpose and does not lose significant activity even after a prolonged service in the containment atmosphere and starts passively at low ambient temperatures is known from German published, non-prosecuted patent application DE 196 36 557 A1, corresponding to U.S. Pat. No. 6,054,108 to Eckardt. A recombination device of this type allows “gentle” recombination of the hydrogen, for example in a phase of the containment atmosphere that contains a vapor and is therefore protected from spontaneous ignition.

European Patent Application, EP 0 527 968 B1 discloses a recombination device, which corresponds to U.S. Pat. Nos. 5,301,217 and 5,473,646. This device utilizes a number of catalyst systems. The catalyst systems are in the form of planar plates that are coated on both sides with catalyst material. The catalyst material can be platinum and/or palladium. This device is particularly suitable for breaking down hydrogen in the atmosphere of the containment of a nuclear power plant. In this case, each catalyst system includes a metal support sheet made from stainless steel. The metal support sheet has a thin layer on both sides. The thickness of the metal support sheet is in the micrometer range. The metal support sheet is preferably made of platinum and/or palladium. A multiplicity of individual plates that have been coated in this way are disposed in a casing, which may be constructed as a module. The monitored gas flow flows into the casing from below and leaves the casing in the upper region through a laterally fitted outlet opening.

European Patent Application EP 0 436 942 A1 discloses a recombiner system with a casing protection device. The casing protection device opens automatically as a function of an outside temperature. When the recombination system is in a state of readiness, the casing protection device, on the other hand, is closed, thus preventing the catalytically active surface of the recombiner from being contaminated.

In contrast, filter media are provided in a recombiner device that is known from EP 0 416 140 A1, which corresponds to U.S. Pat. No. 4,992,407. The filter media retain pollutants from the surrounding atmosphere (e.g. aerosols) and protect the catalyst of the recombination device from contamination.

Furthermore, German published, non-prosecuted patent application DE 37 25 290 A1 discloses precious-metal alloys that absorb or dissipate the heat of reaction generated during the recombination via a metal support sheet or metal mesh. This prevents the gas mixture from igniting.

European Patent Application EP 0 388 955 A1 discloses a recombiner device including an ignition device for initiating controlled combustion of hydrogen.

Every known recombiner system is configured for a particularly high recombiner power with particularly small component dimensions and for a high resistance to contamination. Furthermore, any device for recombination of hydrogen in a gas mixture to be used in a nuclear power plant must not reduce the safety of the nuclear power plant. It should be borne in mind that a catalytic element that is used for recombination of the hydrogen is usually heated as a result of the recombination and, because of its elevated temperature, could undesirably contribute to ignition of the gas mixture within the containment atmosphere of the nuclear power plant.

### SUMMARY OF THE INVENTION

It is accordingly an object of the invention to provide a catalytic element with a restrictor layer that overcomes the hereinafore-mentioned disadvantages of the heretofore-known devices of this general type and that recombines hydrogen and/or carbon monoxide with oxygen in a gas mixture, in particular in a contaminated atmosphere of a nuclear power plant. In particular, the catalytic element should reliably prevent undesirable ignition of the gas mixture during operation.

With the foregoing and other objects in view, there is provided, in accordance with the invention, a catalytic element including a catalyst body with a catalytic surface that achieves the object of the invention. A restrictor layer disposed on the catalytic surface and/or on the catalyst body inhibits the diffusion of the reaction gases flowing therethrough.

The invention recognizes that undesired ignition of the gas mixture near the catalytic element could be caused by an increased reaction temperature at the catalytic element itself. In turn, the heated catalytic element may generate a flame in the surrounding environment. To avoid this, the catalytic element should be constructed to maintain the reaction temperature below the ignition temperature of the gas mixture. This should also be possible in particular for a gas mixture of this type in which the hydrogen gas (H₂) content is more than eight percent by volume (>8% vol.). For this purpose, the diffusion-inhibiting restrictor layer restricts the incoming flow and/or outgoing flow of the reaction gases, with the result that only dynamic adsorption of the reaction gases takes place, and therefore the catalytic reaction is limited to small partial quantities per unit area. In turn, this limits the reaction temperature and maintains the temperature below the ignition point of the gas mixture. Furthermore, in the event of a highly contaminated atmosphere being present, there is a particularly high retention and sorption of catalyst poisons, such as for example aerosols, which occur, with the result that the catalytically active surface of the catalyst body is protected from contamination.

The restrictor layer is expediently porous, with a mean pore diameter of at least five Angstrom, preferably of at least 100 Angström and of at most 10,000 Angstrom. In this case, the restrictor or porous layer preferably includes, in particular in the inflow region of the gas mixture, what are known as macropores with a mean pore diameter of up to 10,000 Angstrom. This allows particularly good supply and/or discharge of the reaction gases. The lower levels of the restrictor layer are disposed near the catalyst body and may include smaller pores, known as micropores with a pore diameter of 5 Angström, preferably of at least 100 Angstrom. This provides a diffusion barrier for the reaction gases. When the catalytic element is operating or even stationary, particles may furthermore become detached from the catalyst body. The fine-pored nature of the restrictor layer prevents the discharge of the so-called “migrating” hot catalyst particles, which may likewise contribute to ignition of the gas mixture surrounding the catalyst body.

The restrictor layer advantageously has a pore volume of at least 0.1 cm³/g and at most 1 cm³/g. A wash coat (Al₂O₃) with a particularly low pore volume is especially suitable. The result is a particularly good diffusion barrier, with at the same time a large surface area. Furthermore, catalyst poisons are retained.

The restrictor layer preferably has a layer thickness of at least 10 μm and at most 1 mm. In a particularly advantageous configuration, the restrictor layer, in the direction of flow of the gas mixture, has a varying layer thickness and/or a varying pore diameter. In this case, the restrictor layer is applied with a particularly great layer thickness or, if the layer thickness is constant, with a particularly small pore diameter in particular in the inflow region of the gas mixture, given standard flow velocities of 0.1 to 2 m/s. The result is a higher dynamic adsorption compared to the outflow region, with a lower incoming and outgoing flow of the reaction gases; this restricts the catalytic reaction. Furthermore, particularly high retention of catalyst poisons is achieved. The layer thickness of the restrictor layer in this case preferably varies in the direction of flow of the gas mixture along the catalyst body. As an alternative and/or in addition, the restrictor layer may have a pore diameter that varies in the direction of flow of the gas mixture through the restrictor layer.

The restrictor layer is preferably ceramic. In this case, the ceramic restrictor layer is expediently porous and has a layer thickness of at most 500 μm. The ceramic restrictor layer preferably includes aluminum oxide or silicon oxide. As an alternative, it is also possible to use another oxide ceramic material, e.g. zirconium oxide, titanium dioxide, or mixtures, such as cordierites, mullites, zeolites, etc.

In accordance with a further object of the invention, the restrictor layer can be a mineral. The mineral restrictor layer is preferably porous and has a layer thickness of at least 1 mm. The mineral restrictor layer particularly advantageously includes a mineral bed, in particular a fragmented basalt bed, having a mean grain size of at least 0.3 mm and of at most 5 mm. A bed of this nature leads to particularly good thermal conduction and absorption.

In accordance with a further object of the invention, the restrictor layer is metallic. In this case, the metallic restrictor layer preferably has a mean pore diameter of at most 50 μm. The metallic restrictor layer preferably includes a permeable metal foil. The metallic restrictor layer may include one or more layers.

To distribute the temperature more evenly and therefore to avoid local centers with increased reaction rates and temperatures, the restrictor layer expediently includes metallic or ceramic fibers. In this case, the fibers are preferably constructed in the manner of a mesh and preferably have a diameter of at most 1 mm and a mean spacing of at most 2 mm. By way of example, the restrictor layer may be in the form of a single-layer perforated metal sheet or in the form of a multilayer screen or fiber configuration. In particular, the configuration of a metallic or ceramic grid in the porous restrictor layer or restrictor bed results in a particularly high resistance to impact and abrasion in order to avoid catalytic abrasion of the catalyst body.

In this case, the various restrictor layers can be applied to the catalyst body with various production processes. For example, the restrictor layer can be sprayed onto the catalyst body like paint that allows particularly accurate dimensioning of the layer thickness of the restrictor layer.

Alternatively, the restrictor layer may be applied by dipping or brushing the catalyst body or by adhesive bonding.

The catalyst body preferably includes a metal support sheet, in particular made from a stainless steel. In this case, the metal support sheet has a thickness of less than or equal to 0.2 mm. Alternatively, the catalyst body includes a planar plate, a perforated plate or a sphere as the mechanical support. Depending on the function and nature of the catalytic recombination, the mechanical support may be of metallic or ceramic form.

For particularly effective recombination of the hydrogen carried in the gas mixture, the catalytic surface contains a catalytic precious metal, in particular platinum or palladium. The catalytic surface is preferably formed by a catalytically active material, such as platinum, palladium or copper, which is applied to a mechanical support with the aid of an adhesion promoter layer and/or an interlayer. Platinum is particularly able to withstand high temperatures and is resistant to catalyst poisons. Furthermore, when using platinum as the catalytically active material, it is possible to recombine carbon monoxide as well as hydrogen. Palladium is particularly suitable because its catalytic property responds even at particularly low ambient temperatures.

The catalytic element having the catalyst body with the catalytic surface and the restrictor layer applied thereto is preferably built up in separate layers as a sandwich structure. In this case, the individual layers are held together by a clamp or a U-shaped metal sheet. The clamp or the metal sheet surrounds the respective end of the catalytic element, with the result that the layers of the catalytic element are held together particularly securely. Furthermore, the catalytic element may be held, for example, in a perforated basket or plug-in cartridge. This allows particularly simple installation in a recombination device that includes a plurality of catalytic elements.

According to a further advantageous configuration, a synthetic resinous fluorine coating sold under the trademark TEFLON® is provided on the restrictor layer at least in the inflow region. The early-start capacity, in particular in damp ambient conditions, may, as a result of a locally delimited synthetic resinous fluorine coating, lead to the generation of temporary hydrophobic properties on the part of the catalyst body. Restricting the quantity of synthetic resinous fluorine coating prevents a quantity of water from being adsorbed within the porous or restrictor layer and therefore improves the early-start capacity (passive reaction initiation).

The advantages of the invention include enabling the catalytic recombination of hydrogen with oxygen by a restrictor layer disposed on the catalytic surface, given a suitable layer thickness or pore diameter. This remains true even in a highly explosive atmosphere, i.e. with a hydrogen gas (H₂) content of approximately fifteen percent by volume (˜15% vol.) in the gas mixture, without ignition being initiated. This is achieved in particular through the diffusion properties of the restrictor layer, which, as a diffusion barrier to the reaction gases, restricts the catalytic reaction. Catalytic abrasion or flaking is reliably avoided by the restrictor layer disposed on the catalytic surface because the restrictor layer covers the catalytically active material, as a protective layer. This is attributable in particular to the good thermal conductivity and the particularly high hardness of the restrictor layer that forms the outer layer of the catalytic element. Furthermore, in addition to inhibiting diffusion through the restrictor layer, a propagating flame from the heat liberated during the recombination of hydrogen can be prevented. Furthermore, a gap width of less than 0.3 mm produces a particularly secure flame barrier.

Other features which are considered as characteristic for the invention are set forth in the appended claims.

Although the invention is illustrated and described herein as embodied in a catalytic element, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, cross-sectional view of a catalytic element for recombination of hydrogen in a gas mixture, having a restrictor layer;

FIG. 2 is an enlarged, fragmentary view showing the restrictor layer in the circle marked III of FIG. 1 having a ceramic restrictor layer;

FIG. 3 is an enlarged, fragmentary view showing an alternate embodiment of the restrictor layer in the circle marked III of FIG. 1 including a mesh in the ceramic restrictor layer;

FIG. 4 is an enlarged, fragmentary view showing an alternate embodiment of the restrictor layer in the circle marked III of FIG. 1 including an additional metallic restrictor layer; and

FIG. 5 is an enlarged, fragmentary view showing an alternate embodiment of the restrictor layer in the circle marked III of FIG. 1 wherein the restrictor layer includes a mineral bed.

### DESCRIPTION OF THE PREFERRED EMBODIMENTS

In all the figures of the drawing, sub-features and integral parts that correspond to one another bear the same reference symbol in each case.

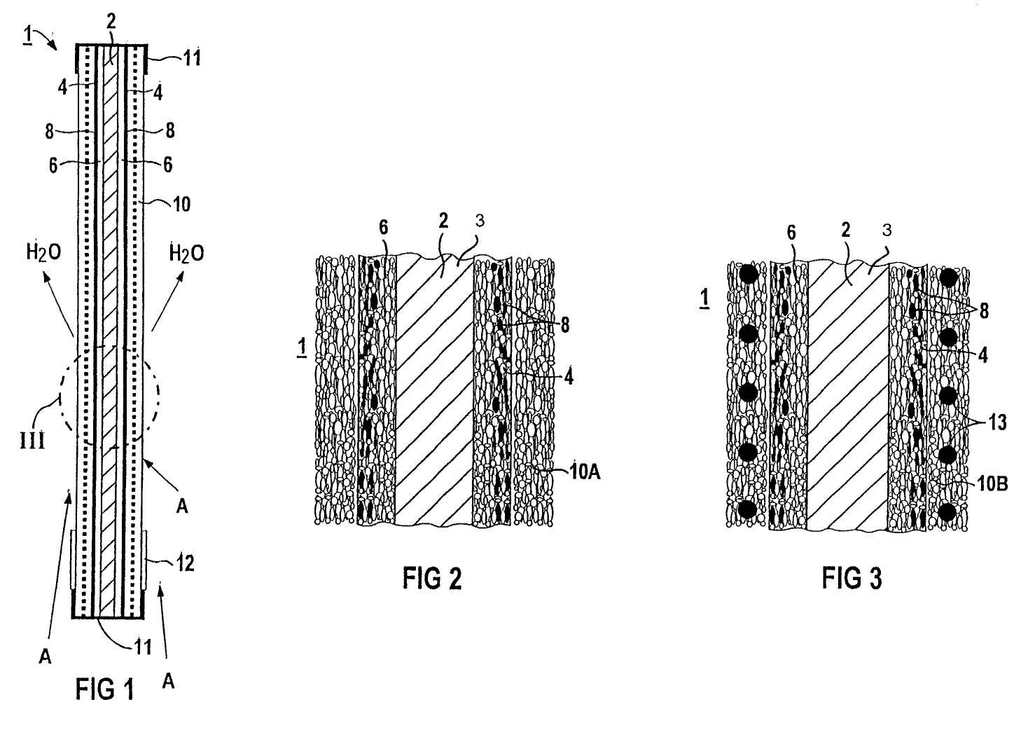

Referring now to the figures of the drawings in detail and first, particularly to FIG. 1 thereof, there is shown a catalytic element 1 provided for recombination of hydrogen and/or carbon monoxide with oxygen in a gas mixture, specifically in the containment atmosphere of an unillustrated recombiner device of a nuclear power plant in the event of a fault. For this purpose, the catalytic element 1 includes a catalyst body 2 with a catalytic surface 4, which is applied to a mechanical carrier 3. The mechanical carrier 3 used is, for example, a metal support sheet, in particular a stainless steel sheet. Alternatively, the mechanical carrier 3 can be embodied as a planar plate, as a perforated plate, as a sphere, or as a plate-shaped support structure containing a bed. The mechanical carrier 3 is preferably metallic or ceramic.

The catalytic surface 4 is in this case formed by a catalytic material 8 that is applied to the catalyst body 2 with the aid of an interlayer 6. This preferably increases the surface area of the catalyst body 2. The interlayer 6 is, for example, mineral, and in particular, the interlayer 6 includes washcoat (Al₂O₃) in which the catalytic material 8 is disposed directly on the surface 4. The catalytic surface 4 includes in particular a catalytic precious metal or a mixture of precious metals or a configuration of precious-metal foils as the catalytically active material 8. The precious metal provided is in particular platinum or palladium.

Furthermore, a restrictor layer 10 for inhibiting the incoming and/or outgoing flow of reaction gases, e.g. H₂, O₂, CO, CO₂, H₂O, is disposed on the catalytic surface 4. The restrictor layer 10 is porous. In the inflow region A of the restrictor layer 10 and therefore directly in the outer region of the catalytic element 1, the pore diameter is at most 10,000 Angstrom. These pores disposed in the outer region are therefore referred to as macropores. The lower levels of the restrictor layer 10, which are disposed in the immediate vicinity of the catalyst body 2, in particular in the region of the catalytic surface 4, have a smaller pore diameter of at least 5 Angströ m, preferably at least 100 Angstrom. Therefore, these lower pores are also referred to as micropores and provide the particularly diffusion-inhibiting property of the restrictor layer 10.

Depending on the diffusion-inhibiting property to be achieved, the restrictor layer 10 may have a layer thickness that varies in the direction of flow of the gas mixture along the catalyst body 2 and/or a pore diameter that varies in the direction of flow of the gas mixture through the restrictor layer 10. The pore volume of the restrictor layer 10 is at least 0.1 cm³/g and at most 1 cm³/g.

A holder 11 is disposed at both the upper and lower ends of the catalytic element 1 to securely hold the components of the catalytic element 1 (i.e., metal support sheet 2, catalytic surface 4, interlayer 6, restrictor layer 10) that are in some cases constructed as a layer or film. The holder 11 used is, for example, a clamp or a U-shaped metal sheet.

In order to prevent quantities of water that could affect the reaction from being adsorbed in the restrictor layer 10, at least the inflow region of the restrictor layer (i.e. at the lower end of the catalytic element 1) is surrounded by a hydrophobic layer 12 that is preferably permeable. The hydrophobic layer 12 used is preferably a synthetic resinous fluorine coating sold under the trademark TEFLON® or a coating with some other substance that has a hydrophobic action.

FIG. 2 shows a detail III of the catalytic element 1 of FIG. 1 with an alternative restrictor layer 10A. The restrictor layer 10A is ceramic and includes, for example, wash coat or silicon oxide. The ceramic restrictor layer 10A is in this case particularly porous and has a layer thickness of at most 500 μm.

FIG. 3 shows a further alternative embodiment of the restrictor layer 10B of the catalytic element 1. The restrictor layer 10B is likewise a ceramic layer in which a mesh 13 is constructed. The mesh 13 is in this case formed from metallic or ceramic fibers, e.g. woven stainless steel or glass fibers. The fibers preferably have a diameter of at most 1 mm and a mean spacing of at most 2 mm. Alternatively, it is also possible to provide a perforated metal sheet or a wire grid. The configuration of the mesh 13 in the restrictor layer 10B makes the latter particularly able to withstand high temperatures and resist abrasion.

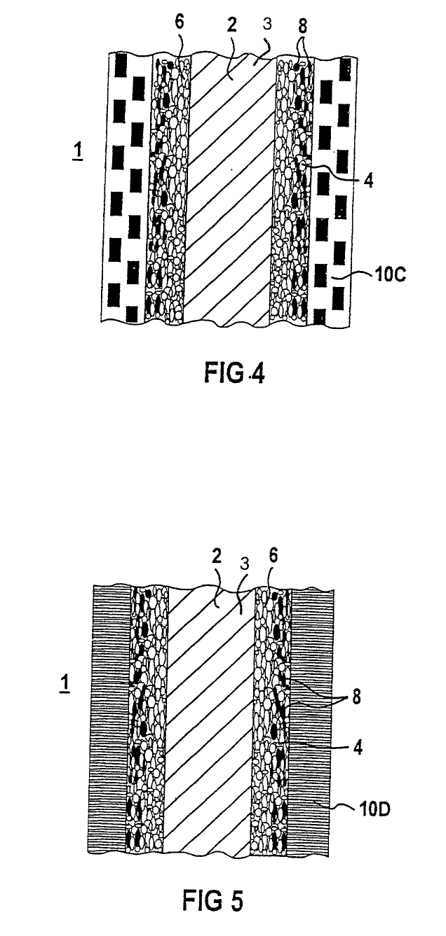

FIG. 4 shows an alternate embodiment in which the catalytic element 1 includes a further alternative restrictor layer 10C, which is metallic. The metallic restrictor layer 10C in this case includes a fine-pored metal foil 14 that is of two-layer construction. The fine-pored metal foil 14 used is, for example, a woven fabric of metal fibers or a perforated metal foil. The individual layers of the metal foil 14 are preferably disposed offset with respect to one another, resulting in a particularly tight woven metal structure that inhibits diffusion particularly successfully.

The catalytic element 1 with a further alternative restrictor layer 10D is illustrated in FIG. 5. In this case, the restrictor layer 10D is formed from a mineral bed. The mineral restrictor layer 10D is porous, with a mean grain size of at least 0.3 mm and at most 5 mm, and with a layer thickness of at least 1 mm. The mineral bed used is, for example, a fragmented basalt bed.

The restrictor layers 10, 10A to 10D have a small volume and include fine and/or coarse pores. The pores lead to the interior of the catalytic element 1. The interior is thereby decoupled with regard to explosions. The interior is decoupled even in a highly explosive environment, in particular, in an environment with a particularly high hydrogen concentration greater than 10% by volume. The gap width of the porous restrictor layer 10, 10A to 10D for a hydrogen concentration of more than 10% by volume should be particularly narrow: preferably less than 0.5 mm.

Furthermore, a narrow gap width of this type results in a particularly reliable flame barrier.

We claim:

1. A catalytic element, comprising:
a catalyst body with a catalytic surface; and
a restrictor layer disposed on said catalyst body for inhibiting diffusion of reaction gases.

2. The catalytic element according to claim 1, wherein said restrictor layer is disposed on said catalytic surface.

3. The catalytic element according to claim 1, wherein said restrictor layer is porous with a mean pore diameter of at least 5 Angstrom.

4. The catalytic element according to claim 3, wherein the mean pore diameter is at least 100 Angstrom.

5. The catalytic element according to claim 3, wherein the mean pore diameter is at most 10,000 Angstrom.

6. The catalytic element according to claim 1, wherein said restrictor layer is porous with a mean pore diameter of at most 10,000 Angstrom.

7. The catalytic element according to claim 1, wherein said restrictor layer has a pore volume of at least 0.1 cm³/g and at most 1 cm³/g.

8. The catalytic element according to claim 1, wherein said restrictor layer has a layer thickness of at least 10 μm and at most 1 mm.

9. The catalytic element according to claim 1, wherein said restrictor layer has a layer thickness varying in the direction of flow of the reaction gasses.

10. The catalytic element according to claim 1, wherein said restrictor layer has a varying pore diameter in the direction of flow of the reaction gasses.

11. The catalytic element according to claim 1, wherein said restrictor layer is ceramic.

12. The catalytic element according to claim 11, wherein said ceramic restrictor layer is porous and has a layer thickness of at most 500 μm.

13. The catalytic element according to claim 11, wherein said ceramic restrictor layer includes aluminum oxide.

14. The catalytic element according to claim 11, wherein said ceramic restrictor layer includes silicon oxide.

15. The catalytic element according to claim 1, wherein said restrictor layer includes minerals.

16. The catalytic element according to claim 15, wherein said mineral restrictor layer is porous and has a layer thickness of at least 1 mm.

17. The catalytic element according to claim 15, wherein said mineral restrictor layer is formed from a mineral bed.

18. The catalytic element according to claim 17, wherein said mineral bed is a fragmented basalt bed.

19. The catalytic element according to claim 17, wherein said mineral bed has a mean grain size of at least 0.3 mm and of at most 5 mm.

20. The catalytic element according to claims 1, wherein said restrictor layer is metallic.

21. The catalytic element according to claim 20, wherein said metallic restrictor layer has a mean pore diameter of at most 50 μm.

22. The catalytic element according to claim 20, wherein said metallic restrictor layer includes a metal foil.

23. The catalytic element according to claim 1, wherein said restrictor layer includes fibers forming a mesh.

24. The catalytic element according to claim 23, wherein said fibers have a diameter of at most 1 mm.

25. The catalytic element according to claim 23, wherein said mesh has a mean spacing of at most 2 mm.

26. The catalytic element according to claim 23, wherein said fibers are metallic.

27. The catalytic element according to claim 23, wherein said fibers are ceramic.

28. The catalytic element according to claim 1, wherein said catalyst body includes a mechanical carrier.

29. The catalytic element according to claim 28, wherein said mechanical carrier is a metal support sheet.

30. The catalytic element according to claim 29, wherein said metal support sheet is made from stainless steel.

31. The catalytic element according to claim 28, wherein said mechanical carrier is a planar plate.

32. The catalytic element according to claim 28, wherein said mechanical carrier is a perforated plate.

33. The catalytic body according to claim 28, wherein said mechanical carrier is a sphere.

34. The catalytic element according to claim 1, wherein said catalytic surface includes a catalytic precious metal.

35. The catalytic element according to claim 34, wherein said catalytic precious metal is platinum.

36. The catalytic element according to claim 34, wherein said catalytic precious metal is palladium.

37. The catalytic element according to claim 1, including:
a mechanical support; and
an adhesion promoter layer attaching said mechanical support to said catalytic surface.

38. The catalytic element according to claim 1, including:
a mechanical support; and
an interlayer attaching said mechanical support to said catalytic surface.

39. The catalytic element according to claim 1, wherein said catalyst body recombines hydrogen with oxygen.

40. The catalytic element according to claim 1, wherein said catalyst body recombines carbon monoxide with oxygen.
